(19) United States
(12) Patent Application Publication
(10) Pub. No.: US 2008/0222044 A1
(43) Pub. Date: Sep. 11, 2008

(54) Protected content renewal

(75) Inventors: Gabriel Gottlieb, Seattle, WA (US); Ken Reneris, Woodinville, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/713,928

(22) Filed: Mar. 5, 2007

(51) Int. Cl. H04L 9/00

(52) U.S. Cl. 705/59

(57) ABSTRACT

Described herein is technology for, among other things, maintaining access to DRM protected content. The technology may be implemented via a playback device or a computer system connected to a MTD. It involves monitoring requests for media content and then verifying access and renewing the license if necessary. The license renewal request may be made to a MTD or an internet connected system.

### BACKGROUND

As computer technology has advanced, computers have come to play an increasing role in media content management and playback. As a result, content protection becomes increasingly important. Without content protection, content may become freely available and widely pirated. Correspondingly, content providers want to protect content from piracy and safeguard revenues.

Digital Rights Management (DRM) protocols have been developed in response to the desire to protect content. Along with receiving a piece of content, a DRM system receives a digital certificate or license which contains, among other things, rules for access and a key to decrypt the content. The rules control a user's access to content in various ways, including time based access, service based access, and the ability to transfer content to other storage media and other devices. Service based access involves restricting access to content based on a subscription a specific service such as a service provider, a specific programming package, or a specific program. The decryption key ensures that only the DRM system is able to access the content and allow playback. Moving the content to a different DRM system loses the ability to tie continued access to the content to a continued valid subscription of the content.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Described herein is technology for, among other things, maintaining access to DRM protected content. The technology may be implemented via a playback device or a computer system coupled to a MTD. It involves monitoring requests for media content and then verifying access and renewing the license if necessary. The license renewal request may be made to a MTD or an internet connected system.

In one implementation, the user may be presented with a visual prompt to renew or increase access rights prior to updating of the license. The license may also be updated transparently in the background. The access verification and renewal request may also be performed prior to the transfer of content to another device. The device receiving the content may be able to make renewal requests independently to an internet connected system or MTD.

Techniques described herein provide for up-to-date content access and renewal of license for DRM protected content. Thus, content providers are able to control access to content with little impact to the user's experience while implementing additional business models.

### BRIEF DESCRIPTION OF THE DRAWINGS

The accompanying drawings, which are incorporated in and form a part of this specification, illustrate embodiments and, together with the description, serve to explain their principles:

FIG. 1 shows an exemplary process for receiving DRM protected content.

FIG. 2 is a block diagram of an exemplary computing system environment for implementing an embodiment.

FIG. 3 shows an exemplary operating environment of a system for maintaining access to DRM protected content in accordance with an embodiment.

FIG. 4 is a block diagram of an exemplary system for playback of DRM protected content, in accordance with an embodiment.

FIG. 5 is a flowchart of a process for maintaining access to DRM protected content, in accordance with an embodiment.

### DETAILED DESCRIPTION

Reference will now be made in detail to the preferred embodiments of the claimed subject matter, examples of which are illustrated in the accompanying drawings. While the invention will be described in conjunction with the preferred embodiments, it will be understood that they are not intended to limit the claimed subject matter to these embodiments. On the contrary, the claimed subject matter is intended to cover alternatives, modifications and equivalents, which may be included within the spirit and scope of the claimed subject matter as defined by the claims. Furthermore, in the detailed description of the present invention, numerous specific details are set forth in order to provide a thorough understanding of the claimed subject matter. However, it will be obvious to one of ordinary skill in the art that the claimed subject matter may be practiced without these specific details. In other instances, well known methods, procedures, components, and circuits have not been described in detail as not to unnecessarily obscure aspects of the claimed subject matter.

Some portions of the detailed descriptions that follow are presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system or similar electronic computing device. For reasons of convenience, and with reference to common usage, these signals are referred to as bits, values, elements, symbols, characters, terms, numbers, or the like with reference to the claimed subject matter.

It should be borne in mind, however, that all of these terms are to be interpreted as referencing physical manipulations and quantities and are merely convenient labels and are to be interpreted further in view of terms commonly used in the art. Unless specifically stated otherwise as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers or other such information storage, transmission, or display devices.

Described herein is technology for, among other things, maintaining access to DRM protected content. A Media Transform Device (MTD) allows media content to be transcrptyed and provided to another device. The technology may be implemented via a playback device or a computer system coupled to a MTD. It involves monitoring requests for media content and then verifying access and renewing the license if necessary. The license renewal request may be made to a MTD or an internet connected system.

In one implementation, the user may be presented with a visual prompt to renew or increase access rights prior to updating of the license. The license may also be updated transparently in the background. The access verification and renewal request may also be performed prior to the transfer of content to another device. The device receiving the content may be able to make renewal requests independently to an internet connected system or MTD.

With recent changes in the broadcast systems, generic broadcast receivers independent of specific content providers have been developed. One such device is a Media Transform Device (MTD) which allows media content to be transcrptyed and provided to another device. A MTD may receive broadcast content from a service provider such as a cable or satellite company and provide the content to a computer. After verifying the subscription for the content, the MTD then transfers the content in another DRM protocol and the associated licenses to an approved piece of software that is considered to be trusted. Once the piece of software has the content, it is responsible for enforcing the rules of the license and more specifically preventing the content from being transferred in a manner in violation of the license. The moving of the content to another DRM system loses the ability to tie continued access of the content to a continued valid subscription to the content.

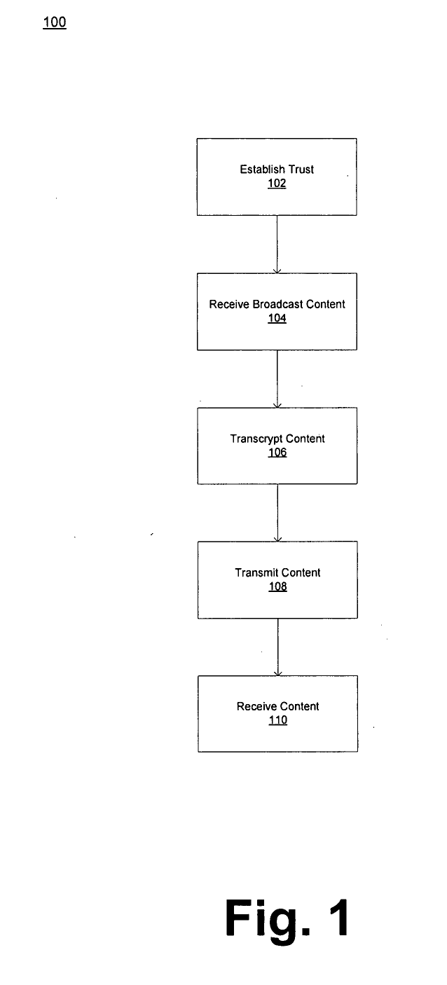

FIG. 1 shows a flowchart of an exemplary process for receiving content on a computer from an MTD device. At step 102, the MTD device establishes a trust relationship with the computer. This can be based on an approved piece of software that is known by the MTD to be allowed to receive content.

After trust has been established, at step 104, the MTD receives broadcast content from the service provider. The content is encrypted by the service provider prior to transmission with a DRM protocol known to the MTD. At step 106, if there is a valid subscription, the MTD transcrypts the content by first decrypting the content and then re-encrypting the content into a DRM protocol known to the trusted software application.

At step 108, the content is transmitted to the computer for receipt by the trusted software application. At step 110, the trusted software application receives the content and may then pass the content off to a playback device or module or store the content on a storage medium in accordance with the DRM protocol.

Once this content is stored on the computer it may sit there indefinitely where it can be accessed by a user. This means that a user has unlimited access to the content in cases where he or she is no longer subscribing to the service provider or a specific programming service such as Pay Per View without having to pay for it. Thus, content providers desire to have the content expire or be unavailable if the subscriptions are discontinued.

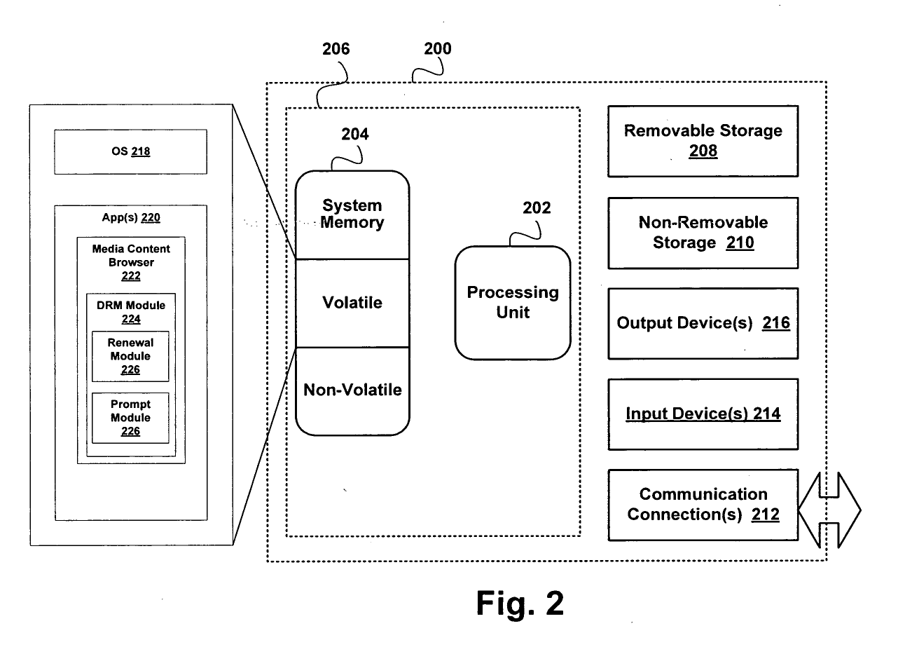

With reference to FIG. 2, an exemplary system for implementing embodiments includes a general purpose computing system environment, such as computing system environment 200. In its most basic configuration, computing system environment 200 typically includes at least one processing unit 202 and memory 204. Depending on the exact configuration and type of computing system environment, memory 204 may be volatile (such as RAM), non-volatile (such as ROM, flash memory, etc.) or some combination of the two. This most basic configuration is illustrated in FIG. 2 by dashed line 202. System memory 204 among other things, includes Operating System 218 (OS) and Applications 220. In one embodiment, applications 220 include a media content browser 222 for browsing and playing various types of media. These various types of media may include, but are not limited to, digital audio, home videos, downloaded videos, satellite broadcasts, radio broadcasts, television broadcasts, cable broadcasts, recorded broadcasts, digital versatile discs (DVDs), programming guides and photographs.

Among other things, media content browser 222 includes DRM module 224 which is responsible for controlling access to media content. This can include checking content licenses prior to playback or a request to transfer media content.

DRM Module 224 further includes license manager 226, a system for maintaining current access to DRM protected content. License manager 226 makes license renewal and upgrade requests to a MTD or internet connected system to receive updated license information and therefore enables DRM module 224 to permit a user to access protected media content. License manager 226 may invoke prompt module 228 which prompts a user to renew or upgrade the current license.

Additionally, computing system environment 200 may also have additional features/functionality. For example, computing system environment 200 may also include additional storage (removable and/or non-removable) including, but not limited to, magnetic or optical disks or tape. Such additional storage is illustrated in FIG. 2 by removable storage 208 and non-removable storage 210. Computer storage media includes volatile and nonvolatile, removable and non-removable media implemented in any method or technology for storage of information such as computer readable instructions, data structures, program modules or other data.

Memory 204, removable storage 208 and nonremovable storage 210 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 200. Any such computer storage media may be part of computing system environment 200.

Computing system environment 200 may also contain communications connection(s) 212 that allow it to communicate with other devices. Communications connection(s) 212 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Communications connection(s) 212 may also allow computing system environment 200 to communication with devices including, but not limited to, TV tuners, DVD players and recorders, digital cameras, web cameras, digital video recorders, radio tuners and programming guides.

Computing system environment 200 may also have input device(s) 214 such as a keyboard, mouse, pen, voice input device, touch input device, remote control, etc. Output device(s) 216 such as a display, speakers, etc. may also be included. All these devices are well known in the art and need not be discussed at length here.

The claimed subject matter is described in terms of these example environments. Description in these terms is provided for convenience only. It is not intended that the invention be limited to application in this example environment. In fact, after reading the following description, it will become apparent to a person skilled in the relevant art how to implement the claimed subject matter in alternative embodiments.

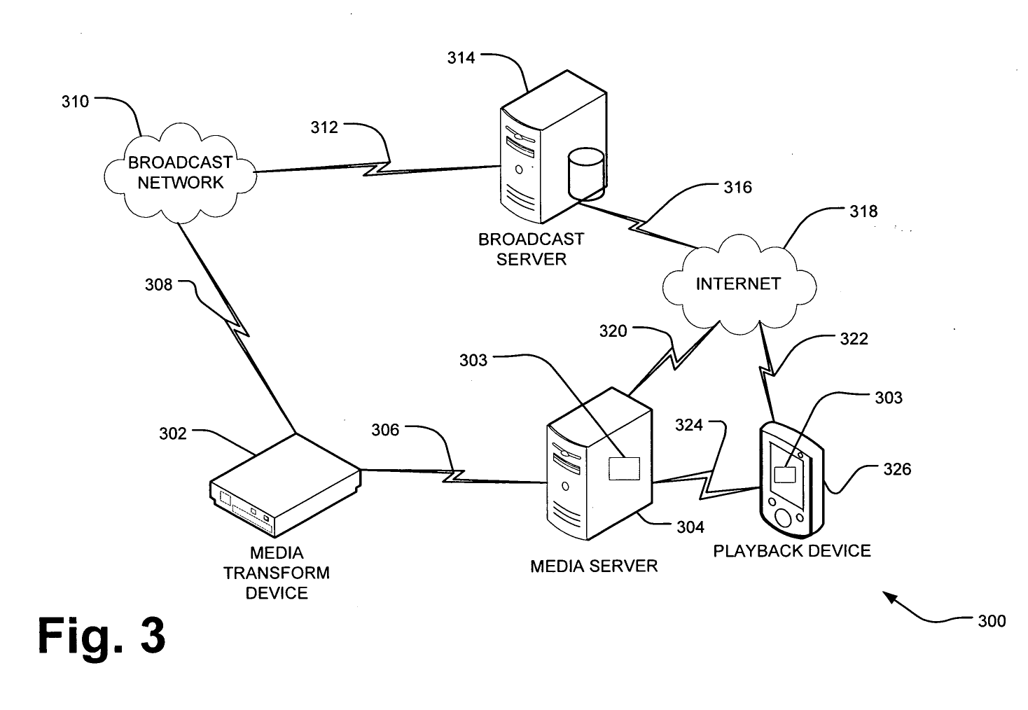

FIG. 3 shows an exemplary operating environment 300 of a system 303 for maintaining access to DRM protected content, in accordance with embodiments. Exemplary network operating environment 300 may be implemented on the operating environments described above. It is appreciated that not all apparatuses in operating environment 300 are necessary for the general goal of system 303 to be achieved. Moreover, it is appreciated that additional apparatuses may also be included operating environment 300 in accordance with alternative embodiments. Exemplary network operating environment 300 can include: MTD 302, media server 304, playback device 326, broadcast network 310, broadcast server 314, internet 318, and system 303 for maximizing bandwidth utilization, and communication links 306, 308, 312, 316, 320, 322, and 324.

Communication link 312 connects broadcast server 314 to broadcast network 310 for distribution of broadcast media content and associated license information. Communication link 312 use wireless or wired communications or any other electronic coupling means for transmitting media content to broadcast network 310.

MTD 302 receives DRM protected content over communication link 308 from broadcast network 310. In one embodiment, MTD 302 may be an Opencable Unidirectional Receiver (OCUR) device for receiving digital media content. Broadcast network 310 may be a cable or satellite service provider network or a combination thereof. Further, broadcast network 310 may distribute content to numerous consumers, businesses, and media outlets.

Media server 304 is an exemplary server as described above as computing system 200 capable of providing and receiving media content. Communication link 306 allows MTD 302 to determine if a trust relationship can be established with media server 304 and thus can receive protected broadcast content. Communication link 306 may be a universal serial bus (USB) connection. MTD 302 may transcrypt content before sending content to media server 304.

System 303 resides in a media server in accordance with one embodiment. System 303 allows for access to content by maintaining license information associated with DRM protected content. Maintaining license information can include renewing and/or updating content licenses prior to expiration as expiration nears. System 303 may store content and associated license information received from MTD 302. System 303 may monitor requests for access to content including local or streaming playback requests and content transfer requests and then issue license renewal and/or upgrade requests accordingly.

In another embodiment, system 303 resides in playback device 326. Playback device 326 is an exemplary playback device as described above as computer system 200 capable of playing and/or storing media. It is appreciated that not all elements of computing system 200 are necessary for the general goal of playback device 326. Moreover, it is appreciated that additional elements may also be included in computing system 200 in accordance with alternative embodiments of playback device 326.

Playback device 326 can be a variety of conventional media rendering or computing devices, including, for example, a set-top box, a television, a video gaming console, a desktop PC, a notebook or portable computer, a workstation, a mainframe computer, an Internet appliance, a handheld PC, a Digital Audio Player (DAP), a Digital Video Player (DVP), a Digital Video Recorder (DVR), a cellular telephone or other wireless communications device, a personal digital assistant (PDA), or combinations thereof.

Communication link 324 connects media server 304 and playback device 326 and facilitates the transfer of protected content from media server 304 to playback device 326. Playback device 326 can support the DRM protocol used by media server 304 and thus is able to playback and control access to the transferred content. In one embodiment, playback device 326 may make a license or renewal or upgrade request to MTD 302 via media server 304 or to another MTD (not shown) communicatively coupled to playback device 326.

Embodiments of system 303 may present visual prompts to a user prior to allowing access to content. Visual prompts can include graphical user interface (GUI) prompts to renew the content license prior to or after expiration and a prompt to upgrade a license to allow additional access levels. For example, an upgraded license may allow a user to burn the content to a DVD. A user's responses to visual prompts can result in a user paying for the license renewal or upgrade. System 303 may also make content renewal requests in the background without prompting a user prior to license expiration.

Communication link 316 connects broadcast server 314 to the internet for among other things broadcasting content and receiving license renewal and upgrade requests. Communication links 320 and 322 connect media server 304 and playback device 326 to internet 318 respectively. Via internet 318, media server 304 and playback device 326 may make license renewal and/or upgrade requests to broadcast server 314 and receive the updated licenses through internet 318. Communication links 320, 322, and 324 can be Ethernet, WiFi, universal serial bus (USB), or any other electronic coupling means.

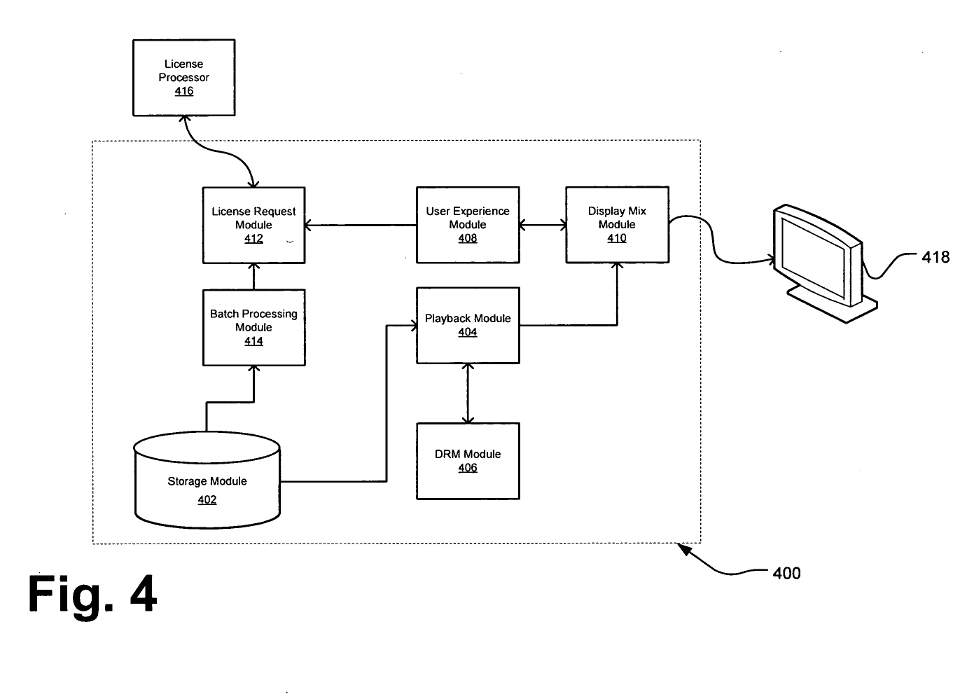

FIG. 4, shows a block diagram of an exemplary system 400 for media playback in accordance with an embodiment. System 400 facilitates the playback of protected content by maintaining the licenses associated with the content. The content may be DRM protected content received from and transcrypted by a MTD. System 400 includes storage module 402, playback module 404, DRM module 406, user experience module 408, display mix module 410, license request module 412, and batch processing module 414. System 400 interacts with license request processor 416 and display device 418 to facilitate playback.

It should be appreciated that the aforementioned modules of system 400 can be implemented in hardware or software or in a combination of both. In one embodiment, modules and operations of system 400 can be encompassed by modules and operations of one or more computer programs that execute on a media server (e.g., 304 in FIG. 3) or playback device (e.g., 326 in FIG. 3). In another embodiment, modules and operations of system 400 can be separate from the aforementioned one or more computer programs but can operate cooperatively with components and operations thereof.

Storage module 402 holds DRM protected content and associated licenses. The content may be from and transcrpyted by a MTD. The associated licenses can contain a key required for accessing the content which is encrypted in a DRM protocol known to system 400. DRM module 406 uses the associated DRM system to decrypt the key and allow playback module 404 to access the content. Further, the licenses may content a content access policy. These policies can include various rules for accessing the content and the length of time the license is valid. For example, the license may can rules allowing playback of the content but not transferring to another playback device or storage medium such as a DVD.

The associated licenses can further contain license chains or hierarchies such as account, service, and content specific level licenses. An account level license can contain information such as the account number, service provider information, and the purchased length of service. The service specific level license can contain information such as a subscription to specific movie channel. The content specific level licenses can contain information such as access to specific television show season, series, or specific episodes. All levels can contain the expiration date or time period of the license. The license chains enable content provides to sell content at numerous levels of granularity. For example, a content provider can sell a whole season of a show, a complete series or specific episodes of a series.

Alternatively, the associated licenses may also be structured in a root-leaf structure. There may be multiple root licenses each having one or more leaves licenses. Each leaf may further have one or more additional leaves. Each root license has a key which is encrypted to the public key of the computer. Each leaf license has a key which is encrypted with the corresponding root license key. For example, a root license for a movie channel will contain the key which is used to decrypt each of the leaf licenses of the movies. Thus, the root-leaf structure allows for various levels of granularity in controlling access to content as leafs may only be accessed if the root or above leaf license has an active subscription.

Storage module 402 may further contain an entitlement token associated with each piece of content. The entitlement token that contains the state of the MTD which contains the information required by the MTD to get and return an updated license. The entitlement token can further contain the key specific to a piece of content so that when the license is updated, only the expiration time or rule is updated and the rest of the license remains unchanged. The entitlement token allows license update requests to be made to devices other than the original MTD that transcrypted the content. Licenses can be updated to other MTDs and broadcast service providers internet servers. For example, when an entitlement token is sent to a broadcast service provider webserver, the information in the entitlement token allows the web server to verify that the license was issued by a MTD that service provider. Thus, playback and renewal of licenses is distributed or independent of the device that original mastered the content.

Playback module 404 facilitates playback of content and presents content to display mix module 410. Content and the associated licenses are received or accessed from storage module 402. The content and licenses are further provided to DRM module 406 for processing. DRM module 406 verifies that a piece of content can be accessed for playback. If the content is accessible for playback, DRM module 406 decrypts the content and provides it to playback module 404. The license may further contain what DRM is to be implemented and supported on output such as macrovision or high definition content protection (HDCP) which the DRM module 406 applies before providing the content to playback module 404.

User experience module 408 provides playback and other media controls along with prompts for license renewal or upgrades to display mix module 410 for display to a user. The prompts can include the option to upgrade or increase the rights under the license or renew an expired license. Based on the feedback from the user, user experience module 408 forwards the appropriate license request to license request module 412. User experience module 408 may receive input from a user through a remote control.

Display mix module 410 combines or overlays playback and control interface of user experience module 408 on content from playback module 404 and send the combination to display device 418. Display mix module 410 may also stream content over a network to a playback device.

License request module 412 sends license information to license request processor 416 for verifying or updating a license. License request module 412 makes renewal or license upgrade requests which are received from batch processing module 414 and user experience module 408. In one embodiment, the license request module 412 sends the entitlement token which provides all the information necessary for the license request processor 416 to return an upgraded license.

License request processor 416 returns an updated license with new expiration or indicates that the license expired to license request module 412. For example, an updated license may allow playback or access to the content for another thirty days. Alternatively, license request processor 416 may indicate that the license is still expired because the user has not paid for continued access. In one embodiment, the entitlement token is used to obtain an updated license from the broadcast service provider. The license request processor 416 may reside in a MTD or a broadcast service provider internet server.

Batch processing module 414 sends renewal requests to license request module 412 upon access of the content in storage module 402. Batch processing module 402 may check the corresponding license chain associated with the content to be played. First, the account level license may be checked to see if the user's account is expired. For example, a request for the current status of a user's subscription to a cable broadcast service provider is checked. Second, the service level license may be checked. For example, the status of the user's current subscription to a movie channel or basic programming package is checked. Third, content specific licenses are checked. For example, the license for a specific movie or pay per view content may be checked for expiration. The licenses may be checked prior to expiration such as each time the content is access or a specific time period before the expiration of the license. The checks and resulting license requests may be made in the background without notification to the user.

Display device 418 is communicatively coupled to system 400 which allows a user to view the output of display mix module 410. In one embodiment, display device 418 may be a computer monitor or television. The user interface from display mix module 410 may feature large graphical elements such that the user interface may be visible from a distance. Prior to display of the output of mix module 410, a trust relationship may be established between system 400 and display device 418 to ensure that content will be protected.

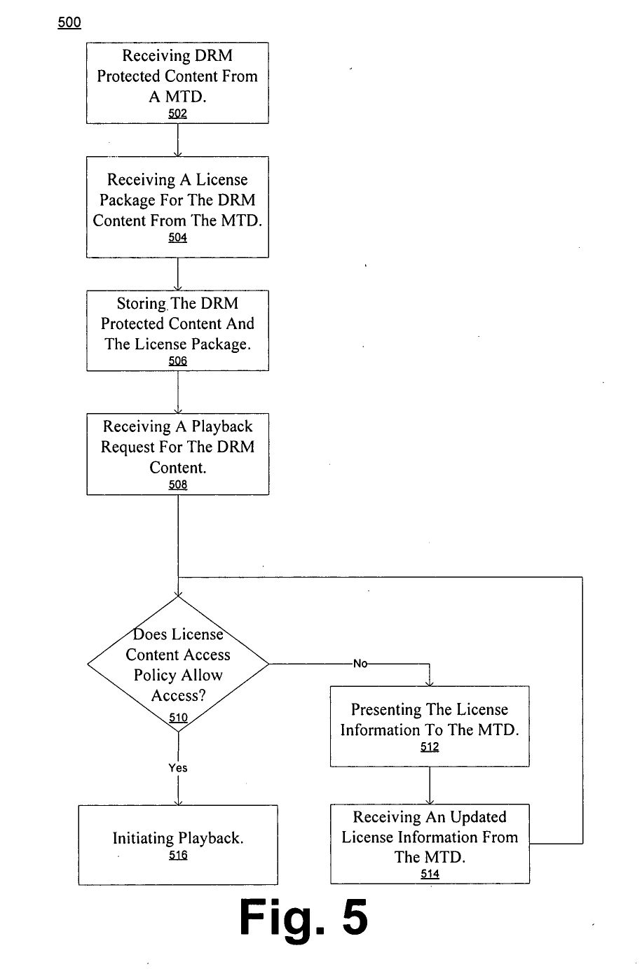

FIG. 5 is a flowchart of an exemplary process 500 for playing DRM protected content, in accordance with an embodiment. Process 500 may be implemented on the operating environments described above. Process 500 is well-suited to be stored as instructions on a computer-readable medium. In an exemplary embodiment, process 500 operates on a media server or playback device. It is appreciated that not all steps of process 500 are necessary for the general goal of process 500 to be achieved. Moreover, it is appreciated that additional steps may also be included in process 500 in accordance with alternative embodiments.

At step 502, DRM protected content is received from a MTD. The MTD receives the content from a broadcast source such as a cable company or a satellite company. The content is transcrypted by the MTD into a known DRM protocol known to the receiving device. The content may be received by a media server or a playback device as described above.

At step 504, a license package is received for the content from the MTD. The license package includes the licenses associated with the content and an entitlement token. The entitlement token contains the information necessary for the MTD to make a request to the service provider to verify or update a license. The license package may further contain license chains as described above.

At step 506, the DRM protected content and the license package is stored. The content and the license package may be stored in the memory or a storage device, such as a hard disk drive, of a media server or a playback device as described above.

At step 508, a playback request of the DRM protected content is received. The request may be from a user to play the content on a playback device connected to the device holding the content. The request may also be from a remote playback device and the content will be streamed over a network to that device.

At step 510, the license content access policy is checked. The license content access policy contains rules which are checked, more specifically, the license expiration rule is checked. The license expiration rule may contain an expiration or time period for which the license is valid. For example, the license expiration rule may not allow the content to be accessed after 24 hours or a specific date and time. If the license is expired, step 512 is performed to start the process of attempting to renew the license. If the license has not expired, step 512 may still be performed if the expiration time remaining is within a preset threshold. For example, attempts to renew the license may be made when the license has one week left before expiration. Otherwise if the license is valid, step 516 is performed and playback is initiated.

At step 512, license information is presented to the MTD so it can check the license with the broadcast service provider. The entitlement token may be presented to the MTD along with the license information to facilitate renewal. If the license information contains a license chain, the license chain may be presented to the MTD starting with the account level, then the service level, and then content specific levels according to the license of the request content. For example, if the license associated with the requested content requires that the account level and service level be active before renewing the content license, the account level and service level licenses are presented to the MTD first. Only after the account and service level licenses are found to be valid will the MTD check content license.

At step 514, updated license information is received from the MTD. If various levels of a license chain have been presented to the MTD, the MTD may return an updated license chain and license information reflecting that the content license is expired or valid based on the one or more of the license levels checked. For example, if the content license requires an active account with a broadcast service provider and active subscription to a programming package, the MTD may return license information that the license is expired based on the account and service level licenses. In one embodiment, the only changed license information received from the OCUR is an updated expiration time or period. If the updated license information allows playback, step 516 is performed and the playback begins.

At step 516, playback of the content is initiated. The playback may be local on a playback device such as a monitor connected to the device storing the content or on another device that receives streaming content over a network.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method for playing DRM protected content, the method comprising:
receiving DRM protected content from a device for receiving digital media content to a computer, wherein said device transcrypts said DRM protected content to a DRM protocol based on a trust relationship with the computer;
receiving a license package for said DRM content from said device;
storing said DRM protected content;
storing said license package;
receiving a playback request for said DRM content;
checking a license content access policy of said DRM content within said license package;
if said license content access policy allows access, initiating playback;
if said license content access policy prevents access:
presenting said license package to said device;
receiving an updated content access policy from said device;
if said updated content access policy allows access, initiating playback.

2. The method as recited in 1 wherein said device for receiving digital media content to a computer is an Opencable Unidirectional Receiver device.

3. The method as recited in claim 1 further comprising:
displaying a prompt to a user if said content access policy prevents access to said DRM protected content.

4. The method as recited in claim 2 wherein said prompt allows a user to renew said license for said DRM content.

5. The method as recited in claim 2 wherein said prompt allows a user to change a plurality of access rights for said DRM content.

6. The method as recited in claim 1 wherein said license package comprises: a plurality of renewal information and a plurality of DRM licenses, wherein each license has a content access policy, the DRM licenses comprising:
an account level license;
a service level license; and
a plurality of content specific level licenses.

7. The method as recited in claim 1 wherein said renewal information comprises uniform resource locaters for renewing a license.

8. A system for handling DRM protected content, the system comprising:
a first adapter for commutatively coupling a system to a device for receiving digital media content to a computer;
a trust module coupled to said first adapter for establishing a trust relationship with said device, wherein said device transcrypts said content to a DRM protocol based on said trust relationship;
a storage device coupled to said first adapter for storing a portion of DRM protected content received from said device and a plurality of license information associated with said DRM protected content, wherein said license information comprises access rules; and
a processor coupled to said storage device for checking access rules of said DRM content and making a renewal request for said DRM protected content.

9. The system as recited in claim 8 further comprising:
An interface for communicatively coupling said system to a playback device.

10. The system as recited in claim 8 wherein said access rules comprise the amount of time said DRM content is able to be played.

11. The system as recited in claim 10 wherein said renewal request is made prior to the expiration of the time in said access rules.

12. The system as recited in claim 8 wherein said renewal request is made to a web server.

13. The system as recited in claim 8 wherein said renewal request is made to an Opencable Unidirectional Receiver device.

14. A computer-readable medium having computer-executable instructions for performing the steps comprising:
detecting a content request for DRM protected content transcrypted from a device for receiving digital media content to a computer;
checking the status of the license associated with said DRM protected content;
performing a renewal request if a license associated with said content has expired; and
receiving an updated license.

15. The computer-readable medium as recited in claim 14 wherein said content request is a playback request.

16. The computer-readable medium as recited in claim 14 wherein said content request is for remote playback of said DRM content.

17. The computer-readable medium as recited in claim 14 wherein said content request is a request to stream said DRM content.

18. The computer-readable medium as recited in claim 14 wherein said content request is a request to transfer said DRM protected content and an associated license package to another device supporting said DRM protocol.

19. The computer-readable medium as recited in claim 18 wherein said device can make renewal requests for said DRM content.

20. The computer-readable medium as recited in claim 19 wherein said device makes renewal requests to a web server.
